(19) United States
(12) Patent Application Publication
(10) Pub. No.: US 2021/0194122 A1
(43) Pub. Date: Jun. 24, 2021

(54) ANTENNA DEVICE AND WIRELESS COMMUNICATION DEVICE

(71) Applicant: Mitsubishi Electric Corporation, Tokyo (JP)

(72) Inventors: Shimpei AKIMOTO, Tokyo (JP); Kengo NISHIMOTO, Tokyo (JP); Yasuhiro NISHIOKA, Tokyo (JP)

(73) Assignee: Mitsubishi Electric Corporation, Tokyo (JP)

(21) Appl. No.: 16/966,752

(22) PCT Filed: Feb. 22, 2018
(86) PCT No.: PCT/JP2018/006534

§ 371 Date: Jul. 31, 2020

(51) Int. Cl. H01Q 1/52; H01Q 3/38

(52) U.S. Cl. CPC H01Q 1/523; H01Q 3/38

(57) ABSTRACT

An antenna device (4) includes a first phase shifter (24) having one end connected to a fourth terminal (23d) of a directional coupler (23); a second phase shifter (25) having one end connected to a first terminal (23a) of the directional coupler (23); a third phase shifter (26) having one end connected to a second terminal (23b) of the directional coupler (23); a first matching circuit (27) having one end connected to an other end of the second phase shifter (25) and having an other end connected to a first input/output terminal (11); and a second matching circuit (28) having one end connected to an other end of the third phase shifter (26) and having an other end connected to a second input/output terminal (12).

### TECHNICAL FIELD

The present invention relates to an antenna device including a first radiating element and a second radiating element, and a wireless communication device including the antenna device.

### BACKGROUND ART

The following Patent Literature 1 discloses a circularly polarized wave switching antenna for radiating a right-hand circularly polarized wave or a left-hand circularly polarized wave.

The circularly polarized wave switching antenna includes the following components (1) to (4):

(1) a radiating element having two feed points and configured to radiate two linearly polarized waves orthogonal to each other;

(2) a first phase shifter with one end connected to one feed point of the radiating element and configured to shift the phase of a signal by 0 degrees or 180 degrees;

(3) a second phase shifter with one end connected to the other feed point of the radiating element and configured to shift the phase of a signal by 0 degrees or 180 degrees; and

(4) a 90°-hybrid circuit for splitting an input signal into two signals with a phase difference of 90 degrees, outputting one split signal to the first phase shifter, and outputting the other split signal to the second phase shifter.

### CITATION LIST

### Patent Literatures

Patent Literature 1: JP 2000-223942 A

### SUMMARY OF INVENTION

### Technical Problem

Suppose an antenna device is obtained by removing the radiating element in (1) and the first phase shifter in (2) from the known circularly polarized wave switching antenna and adding a first radiating element and a second radiating element to it.

In such a supposed antenna device, further suppose that the first radiating element is connected to a first output terminal of the 90°-hybrid circuit, and that the second radiating element is connected to a second output terminal of the 90°-hybrid circuit through the second phase shifter.

Such a supposed antenna device can function as a four-branch diversity antenna by switching the amounts of phase shift of the second phase shifter.

However, in the supposed antenna device, in a case in which the distance between the first radiating element and the second radiating element is short, for example, equal to or less than one-half of the wavelength of operating frequency, mutual coupling between the first radiating element and the second radiating element is strengthened. As the mutual coupling between the first radiating element and the second radiating element becomes stronger, a larger part of one or more signals radiated from the first radiating element enters the second radiating element. There is a problem that by a large part of the one or more signals radiated from the first radiating element entering the second radiating element, signal reflection increases.

Some embodiments in this disclosure have been made to solve a problem such as that described above, and an object of some embodiments in this disclosure is to obtain an antenna device capable of suppressing signal reflection even if the distance between two radiating elements is short.

In addition, another object of the invention is to obtain a wireless communication device including an antenna device capable of suppressing signal reflection.

### Solution to Problem

An antenna device according to this disclosure includes a directional coupler for splitting, when a signal is inputted to the directional coupler from a first terminal or a second terminal, the signal into signals, outputting one split signal to a third terminal, and outputting an other split signal to a fourth terminal; a first radiating element connected to the third terminal; a first phase shifter having one end connected to the fourth terminal; a second radiating element connected to an other end of the first phase shifter; a second phase shifter having one end connected to the first terminal; a third phase shifter having one end connected to the second terminal; a first matching circuit having one end connected to an other end of the second phase shifter and having an other end connected to a first input/output terminal; and a second matching circuit having one end connected to an other end of the third phase shifter and having an other end connected to a second input/output terminal.

### Advantageous Effects of Invention

According to this disclosure, the antenna device is constructed to include the first phase shifter having one end connected to the fourth terminal of the directional coupler; the second phase shifter having one end connected to the first terminal of the directional coupler; the third phase shifter having one end connected to the second terminal of the directional coupler; the first matching circuit having one end connected to the other end of the second phase shifter and having the other end connected to the first input/output terminal; and the second matching circuit having one end connected to the other end of the third phase shifter and having the other end connected to the second input/output terminal. Therefore, the antenna device according to this disclosure can suppress signal reflection even if the distance between two radiating elements is short.

### BRIEF DESCRIPTION OF DRAWINGS

FIG. 1 is a configuration diagram showing a wireless communication device including an antenna device 4 according to Embodiment 1.

FIG. 2 is a configuration diagram showing the antenna device 4 according to Embodiment 1.

FIG. 3 is a configuration diagram showing a first phase shifter 24, a second phase shifter 25, and a third phase shifter 26.

FIG. 4 is an illustrative diagram showing a relationship among two diversity modes, four branches, the amounts of phase shift of the first to third phase shifters, feed points, and the phase difference between the excitation phase of a first radiating element 21 and the excitation phase of a second radiating element 22.

FIG. 5 is an illustrative diagram showing a coupling from a first input/output terminal 11 to a second input/output terminal 12.

FIG. 6 is an illustrative diagram showing reflections of transmission signals at the first input/output terminal 11.

FIG. 7 is an illustrative diagram showing a two-element antenna array.

FIG. 8A is a Smith chart showing S-parameters and FIG. 8B is an illustrative diagram showing frequency characteristics of amplitude.

FIG. 9A is a Smith chart showing S-parameters for a case of a mode (1) and FIG. 9B is a Smith chart showing S-parameters for a case of a mode (2).

FIG. 10A is a Smith chart showing S-parameters for a case of the mode (1) and FIG. 10B is a Smith chart showing S-parameters for a case of the mode (2).

FIG. 11A is a Smith chart showing S-parameters for a case of the mode (1) and FIG. 11B is a Smith chart showing S-parameters for a case of the mode (2).

FIG. 12 is an illustrative diagram showing simulation results of radiation patterns obtained when a branch (1) in the mode (1) is used and the feed point is the first input/output terminal 11.

FIG. 13 is an illustrative diagram showing simulation results of radiation patterns obtained when a branch (2) in the mode (1) is used and the feed point is the second input/output terminal 12.

FIG. 14 is an illustrative diagram showing simulation results of radiation patterns obtained when a branch (3) in the mode (2) is used and the feed point is the first input/output terminal 11.

FIG. 15 is an illustrative diagram showing simulation results of radiation patterns obtained when a branch (4) in the mode (2) is used and the feed point is the second input/output terminal 12.

FIG. 16 is an illustrative diagram showing simulation results for correlation coefficients between the branches (1) to (4).

FIG. 17 is a configuration diagram showing another antenna device 4 according to Embodiment 1.

FIG. 18 is a configuration diagram showing an antenna device 4 according to Embodiment 2.

FIG. 19 is a configuration diagram showing a branch-line 90°-hybrid circuit.

FIG. 20 is a configuration diagram showing a directional coupler 60 including capacitors and inductors.

FIG. 21 is a configuration diagram showing a directional coupler 60 including four capacitors in total.

### DESCRIPTION OF EMBODIMENTS

To describe the invention in more detail, embodiments for carrying out the invention will be explained below in accordance with the accompanying drawings.

### Embodiment 1

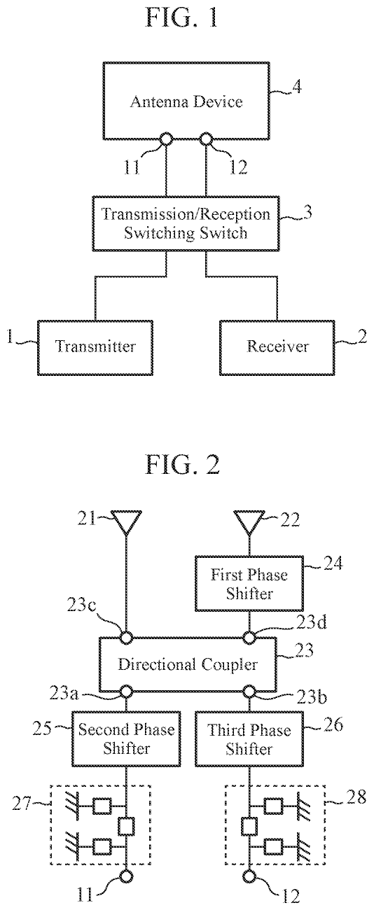

FIG. 1 is a configuration diagram showing a wireless communication device including an antenna device 4 according to Embodiment 1.

In FIG. 1, a transmitter 1 is a communication device for outputting transmission signals to a transmission/reception switching switch 3.

A receiver 2 is a communication device for performing reception processes on reception signals outputted from the transmission/reception switching switch 3.

The transmission/reception switching switch 3 outputs the transmission signals outputted from the transmitter 1 to a first input/output terminal 11 or a second input/output terminal 12 of the antenna device 4, and outputs the reception signals outputted from the first input/output terminal 11 or the second input/output terminal 12 to the receiver 2.

The antenna device 4 has the first input/output terminal 11 and the second input/output terminal 12.

The antenna device 4 functions as a four-branch diversity antenna, using two antennas.

The first input/output terminal 11 is a terminal for accepting, as input, transmission signals outputted from the transmission/reception switching switch 3, or outputting reception signals of the antenna device 4 to the transmission/reception switching switch 3.

The second input/output terminal 12 is a terminal for accepting, as input, transmission signals outputted from the transmission/reception switching switch 3, or outputting reception signals of the antenna device 4 to the transmission/reception switching switch 3.

FIG. 2 is a configuration diagram showing the antenna device 4 according to Embodiment 1.

In FIG. 2, a first radiating element 21 is an antenna connected to a third terminal 23c of a directional coupler 23.

A second radiating element 22 is an antenna connected to a first phase shifter 24.

The directional coupler 23 is, for example, a branch-line directional coupler and has a first terminal 23a, a second terminal 23b, the third terminal 23c, and a fourth terminal 23d.

The first terminal 23a is connected to one end of a second phase shifter 25.

The second terminal 23b is connected to one end of a third phase shifter 26.

The third terminal 23c is connected to the first radiating element 21.

The fourth terminal 23d is connected to one end of the first phase shifter 24.

The directional coupler 23 is implemented as, for example, a branch-line directional coupler or a rat-race directional coupler.

When, for example, a transmission signal is inputted to the directional coupler 23 from the first terminal 23a or the second terminal 23b, the directional coupler 23 splits the transmission signal into two transmission signals.

Then, the directional coupler 23 outputs one split transmission signal to the third terminal 23c, and outputs the other split transmission signal to the fourth terminal 23d.

When the transmission signal is inputted from the first terminal 23a, the phase difference of the other split transmission signal with respect to one split transmission signal is ϕ degrees.

When the transmission signal is inputted from the second terminal 23b, the phase difference of one split transmission signal with respect to the other split transmission signal is (π−ϕ) degrees.

When, for example, a reception signal is inputted to the directional coupler 23 from the third terminal 23c or the fourth terminal 23d, the directional coupler 23 splits the reception signal into two reception signals.

Then, the directional coupler 23 outputs one split reception signal to the first terminal 23a, and outputs the other split reception signal to the second terminal 23b.

When the reception signal is inputted from the third terminal 23c, the phase difference of the other split reception signal with respect to one split reception signal is (π−ϕ) degrees.

When the reception signal is inputted from the fourth terminal 23d, the phase difference of one split reception signal with respect to the other split reception signal is degrees.

In Embodiment 1, as the directional coupler 23, for example, a directional coupler with a degree of coupling of √0.5 (3 dB) is used.

The first phase shifter 24 is connected at its one end to the fourth terminal 23d and connected at its other end to the second radiating element 22.

The first phase shifter 24 is a phase shifter that can switch the amount of phase shift to 0 degrees or θ degrees.

When a transmission signal is outputted from the fourth terminal 23d, the first phase shifter 24 shifts the phase of the transmission signal by 0 degrees or θ degrees, and outputs the phase-shifted transmission signal to the second radiating element 22.

When a reception signal is outputted from the second radiating element 22, the first phase shifter 24 shifts the phase of the reception signal by 0 degrees or θ degrees, and outputs the phase-shifted reception signal to the fourth terminal 23d.

The second phase shifter 25 is connected at its one end to the first terminal 23a and connected at its other end to a first matching circuit 27.

The second phase shifter 25 is a phase shifter that can switch the amount of phase shift to 0 degrees or one-half of θ (hereinafter, represented as “θ/2”) degrees.

When a transmission signal is outputted from the first matching circuit 27, the second phase shifter 25 shifts the phase of the transmission signal by 0 degrees or θ/2 degrees, and outputs the phase-shifted transmission signal to the first terminal 23a.

When a reception signal is outputted from the first terminal 23a, the second phase shifter 25 shifts the phase of the reception signal by 0 degrees or θ/2 degrees, and outputs the phase-shifted reception signal to the first matching circuit 27.

The third phase shifter 26 is connected at its one end to the second terminal 23b and connected at its other end to a second matching circuit 28.

The third phase shifter 26 is a phase shifter that can switch the amount of phase shift to 0 degrees or θ/2 degrees.

When a transmission signal is outputted from the second matching circuit 28, the third phase shifter 26 shifts the phase of the transmission signal by 0 degrees or θ/2 degrees, and outputs the phase-shifted transmission signal to the second terminal 23b.

When a reception signal is outputted from the second terminal 23b, the third phase shifter 26 shifts the phase of the reception signal by 0 degrees or θ/2 degrees, and outputs the phase-shifted reception signal to the second matching circuit 28.

The first matching circuit 27 is connected at its one end to the other end of the second phase shifter 25 and connected at its other end to the first input/output terminal 11.

The first matching circuit 27 is a circuit for matching the impedance seen from the first input/output terminal 11 toward a second phase shifter 25 to the impedance seen from the first input/output terminal 11 toward a transmission/reception switching switch 3.

The second matching circuit 28 is connected at its one end to the other end of the third phase shifter 26 and connected at its other end to the second input/output terminal 12.

The second matching circuit 28 is a circuit for matching the impedance seen from the second input/output terminal 12 toward a third phase shifter 26 to the impedance seen from the second input/output terminal 12 toward the transmission/reception switching switch 3.

Although FIG. 2 shows an example in which each of the first matching circuit 27 and the second matching circuit 28 is a Π-circuit including three lumped elements, each circuit is not limited thereto and may be a Π-circuit including two or less lumped elements.

In addition, each of the first matching circuit 27 and the second matching circuit 28 may be, for example, a T-circuit including three or less lumped elements.

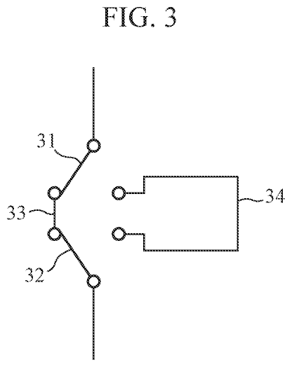

FIG. 3 is a configuration diagram illustrating the first phase shifter 24, the second phase shifter 25, and the third phase shifter 26.

Each of the first phase shifter 24, the second phase shifter 25, and the third phase shifter 26 can use a switched-line phase shifter such as that shown in FIG. 3.

In FIG. 3, each of a switch 31 and a switch 32 is implemented by, for example, a Single-Pole Double-Throw (SPDT) switch.

A line 33 is a line for connecting the switches 31 and 32. The line 33 is a short line with a line length being able to be ignored. Thus, it is supposed that the line 33 does not affect the phase of a signal passing through the line 33.

A bypass line 34 is a line with a length corresponding to an amount of phase shift of a phase shifter.

As for the case in which the phase shifter shown in FIG. 3 is the first phase shifter 24, the bypass line 34 has a length corresponding to the amount of phase shift θ.

In the case in which the phase shifter shown in FIG. 3 is the first phase shifter 24, each of the switch 31 and the switch 32 is connected to the line 33 to set the amount of phase shift to 0 degrees. By connecting each of the switch 31 and the switch 32 to the line 33, the fourth terminal 23d is connected to the second radiating element 22.

In the case in which the amount of phase shift is to be set to 0 degrees, each of the switch 31 and the switch 32 is connected to the bypass line 34. By connecting each of the switch 31 and the switch 32 to the bypass line 34, the fourth terminal 23d is connected to one end of the bypass line 34 and the other end of the bypass line 34 is connected to the second radiating element 22.

Furthermore, as for the case in which the phase shifter shown in FIG. 3 is the second phase shifter 25, the bypass line 34 has a length corresponding to the amount of phase shift θ/2.

In the case in which the phase shifter shown in FIG. 3 is the second phase shifter 25, each of the switch 31 and the switch 32 is connected to the line 33 to set the amount of phase shift of the second phase shifter 25 to 0 degrees. By connecting each of the switch 31 and the switch 32 to the line 33, the first terminal 23a is connected to the one end of the first matching circuit 27.

In the case in which the amount of phase shift is to be set to one-half of 0 degrees, each of the switch 31 and the switch 32 is connected to the bypass line 34. By connecting each of the switch 31 and the switch 32 to the bypass line 34, the first terminal 23a is connected to the one end of the bypass line 34 and the other end of the bypass line 34 is connected to the one end of the first matching circuit 27.

Furthermore, as for the case in which the phase shifter shown in FIG. 3 is the third phase shifter 26, the bypass line 34 has a length corresponding to the amount of phase shift θ/2.

In the case in which the phase shifter shown in FIG. 3 is the third phase shifter 26, each of the switch 31 and the switch 32 is connected to the line 33 to set the amount of phase shift to 0 degrees. By connecting each of the switch 31 and the switch 32 to the line 33, the second terminal 23b is connected to the one end of the second matching circuit 28.

In the case in which the amount of phase shift of the third phase shifter 26 is to be set to one-half of 0 degrees, each of the switch 31 and the switch 32 is connected to the bypass line 34. By connecting each of the switch 31 and the switch 32 to the bypass line 34, the second terminal 23b is connected to the one end of the bypass line 34 and the other end of the bypass line 34 is connected to the one end of the second matching circuit 28.

Note that each of the switch 31 and the switch 32 may be operated by a control device which is not shown, or may be manually operated by a user.

Next, operations of the wireless communication device shown in FIG. 1 will be described.

The antenna device 4 can function as a four-branch diversity antenna by switching the respective amounts of phase shift of the first phase shifter 24, the second phase shifter 25, and the third phase shifter 26.

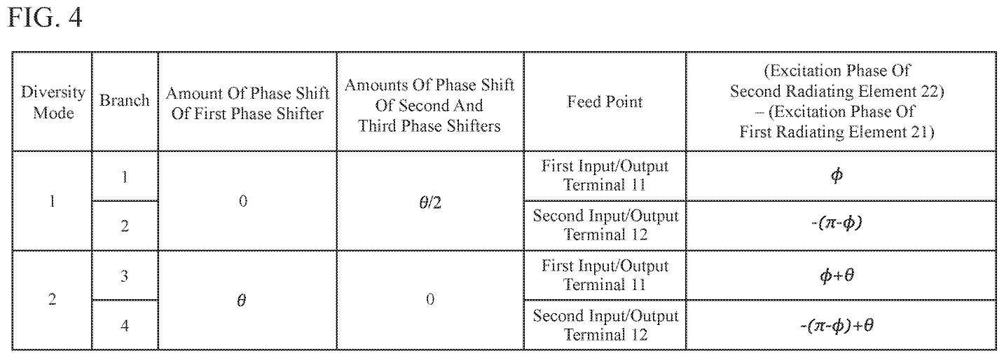

FIG. 4 is an illustrative diagram showing a relationship among two diversity modes, four branches, the amounts of phase shift of the first to third phase shifters, feed points, and the phase difference between the excitation phase of the first radiating element 21 and the excitation phase of the second radiating element 22.

The antenna device 4 has the first input/output terminal 11 and the second input/output terminal 12 as feed points.

A mode (1) of the diversity mode includes a branch (1) and a branch (2), and a mode (2) of the diversity mode includes a branch (3) and a branch (4).

Although here an example in which the wireless communication device uses the antenna device 4 as a transmission antenna is explained, it is obvious that even if the wireless communication device uses the antenna device 4 as a reception antenna, the same advantageous effects can be obtained by the reversibility of the antenna device 4.

The transmitter 1 outputs a transmission signal to the transmission/reception switching switch 3.

When the transmission/reception switching switch 3 receives the transmission signal outputted from the transmitter 1, if, for example, the diversity mode of the antenna device 4 is set to the mode (1) and the branch is set to the branch (1), then the transmission/reception switching switch 3 outputs the transmission signal to the first input/output terminal 11.

When the diversity mode of the antenna device 4 is set to the mode (1) and the branch is set to the branch (2), the transmission/reception switching switch 3 outputs the transmission signal to the second input/output terminal 12.

When the diversity mode of the antenna device 4 is set to the mode (2) and the branch is set to the branch (3), the transmission/reception switching switch 3 outputs the transmission signal to the first input/output terminal 11.

When the diversity mode of the antenna device 4 is set to the mode (2) and the branch is set to the branch (4), the transmission/reception switching switch 3 outputs the transmission signal to the second input/output terminal 12.

Each of the diversity mode and branch of the antenna device 4 is, for example, set by a control device which is not shown or set by a manual operation by the user.

For example, by the control device setting the branch to the branch (1) or the branch (3), a transmission signal outputted to the first input/output terminal 11 from the transmission/reception switching switch 3 reaches the second phase shifter 25 through the first matching circuit 27.

As shown in FIG. 4, when the branch is the branch (1), the diversity mode is the mode (1), and thus, the amount of phase shift of the second phase shifter 25 is set to θ/2 degrees.

As shown in FIG. 4, when the branch is the branch (3), the diversity mode is the mode (2), and thus, the amount of phase shift of the second phase shifter 25 is set to 0 degrees.

Therefore, when the branch is the branch (1), the second phase shifter 25 shifts the phase of the transmission signal by θ/2 degrees, and outputs the transmission signal shifted in phase by θ/2 degrees to the first terminal 23a.

When the branch is the branch (3), the second phase shifter 25 shifts the phase of the transmission signal by 0 degrees, and outputs the transmission signal shifted in phase by 0 degrees to the first terminal 23a.

For example, by the control device setting the branch to the branch (2) or the branch (4), a transmission signal outputted to the second input/output terminal 12 from the transmission/reception switching switch 3 reaches the third phase shifter 26 through the second matching circuit 28.

As shown in FIG. 4, when the branch is the branch (2), the diversity mode is the mode (1), and thus, the amount of phase shift of the third phase shifter 26 is set to θ/2 degrees.

As shown in FIG. 4, when the branch is the branch (4), the diversity mode is the mode (2), and thus, the amount of phase shift of the third phase shifter 26 is set to 0 degrees.

Therefore, when the branch is the branch (2), the third phase shifter 26 shifts the phase of the transmission signal by θ/2 degrees, and outputs the transmission signal shifted in phase by θ/2 degrees to the second terminal 23b.

When the branch is the branch (4), the third phase shifter 26 shifts the phase of the transmission signal by 0 degrees, and outputs the transmission signal shifted in phase by 0 degrees to the second terminal 23b.

When the transmission signal is outputted to the first terminal 23a from the second phase shifter 25 in a case in which the branch is the branch (1) or the branch (3), the directional coupler 23 accepts, as input, the transmission signal from the first terminal 23a and divides the power of the transmission signal into two parts, and thereby splits the transmission signal into two transmission signals.

At this time, the directional coupler 23 splits the transmission signal into two transmission signals in such a manner that the phase difference of a transmission signal outputted to the fourth terminal 23d with respect to a transmission signal outputted to the third terminal 23c is ϕ degrees.

The directional coupler 23 outputs one split transmission signal to the third terminal 23c and outputs the other split transmission signal to the fourth terminal 23d.

When the transmission signal is outputted to the second terminal 23b from the third phase shifter 26 in a case in which the branch is the branch (2) or the branch (4), the directional coupler 23 accepts, as input, the transmission signal from the second terminal 23b and divides the power of the transmission signal into two parts, and thereby splits the transmission signal into two transmission signals.

At this time, the directional coupler 23 splits the transmission signal into two transmission signals in such a manner that the phase difference of a transmission signal outputted to the third terminal 23c with respect to a transmission signal outputted to the fourth terminal 23d is (π−ϕ) degrees.

The directional coupler 23 outputs one split transmission signal to the third terminal 23c and outputs the other split transmission signal to the fourth terminal 23d.

The transmission signal outputted from the third terminal 23c reaches the first radiating element 21.

The transmission signal outputted from the fourth terminal 23d reaches the first phase shifter 24.

As shown in FIG. 4, when the diversity mode is the mode (1), the amount of phase shift of the first phase shifter 24 is set to 0 degrees, and when the diversity mode is the mode (2), the amount of phase shift of the first phase shifter 24 is set to 0 degrees.

Therefore, when the diversity mode is the mode (1), the first phase shifter 24 shifts the phase of the transmission signal outputted from the fourth terminal 23d by 0 degrees, and outputs the transmission signal shifted in phase by 0 degrees to the second radiating element 22.

When the diversity mode is the mode (2), the first phase shifter 24 shifts the phase of the transmission signal outputted from the fourth terminal 23d by 0 degrees, and outputs the transmission signal shifted in phase by 0 degrees to the second radiating element 22.

The first radiating element 21 radiates the transmission signal outputted from the third terminal 23c into space.

The second radiating element 22 radiates the transmission signal outputted from the first phase shifter 24 into space.

When the branch is the branch (1), if the phase of the transmission signal inputted from the first input/output terminal 11 is 0 degrees, then the excitation phase of the first radiating element 21 is θ/2 degrees, and the excitation phase of the second radiating element 22 is (θ/2+ϕ) degrees. Here, for simplification of description, the phase rotation of the transmission signal when passing through the first matching circuit 27 and the phase rotation of the transmission signal when passing from the first terminal 23a to the third terminal 23c are ignored.

Therefore, the difference of the excitation phase of the second radiating element 22 with respect to the excitation phase of the first radiating element 21 is degrees.

When the branch is the branch (2), if the phase of the transmission signal inputted from the second input/output terminal 12 is 0 degrees, then the excitation phase of the first radiating element 21 is θ/2+(π−ϕ)) degrees, and the excitation phase of the second radiating element 22 is θ/2 degrees. Here, for simplification of description, the phase rotation of the transmission signal when passing through the second matching circuit 28 and the phase rotation of the transmission signal when passing from the second terminal 23b to the fourth terminal 23d are ignored.

Therefore, the difference of the excitation phase of the second radiating element 22 with respect to the excitation phase of the first radiating element 21 is −(π−ϕ) degrees.

When the branch is the branch (3), if the phase of the transmission signal inputted from the first input/output terminal 11 is 0 degrees, then the excitation phase of the first radiating element 21 is 0 degrees, and the excitation phase of the second radiating element 22 is (ϕ+θ) degrees.

Therefore, the difference of the excitation phase of the second radiating element 22 with respect to the excitation phase of the first radiating element 21 is (ϕ+θ) degrees.

When the branch is the branch (4), if the phase of the transmission signal inputted from the second input/output terminal 12 is 0 degrees, then the excitation phase of the first radiating element 21 is (π−ϕ) degrees, and the excitation phase of the second radiating element 22 is 0 degrees.

Therefore, the difference of the excitation phase of the second radiating element 22 with respect to the excitation phase of the first radiating element 21 is (−(π−ϕ)+θ) degrees.

Thus, the antenna device 4 can form four different radiation patterns by switching the respective amounts of phase shift of the first phase shifter 24, the second phase shifter 25, and the third phase shifter 26 as shown in FIG. 4.

Here, if the distance between the first radiating element 21 and the second radiating element 22 is short, mutual coupling between the first radiating element 21 and the second radiating element 22 is increased.

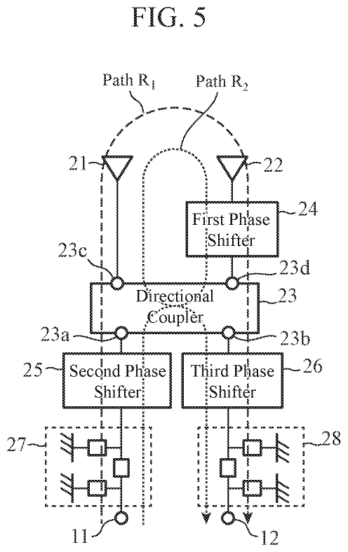

If signal reflection at the first radiating element 21 is 0 and signal reflection at the second radiating element 22 is 0, as a coupling from the first input/output terminal 11 to the second input/output terminal 12, there is a possible coupling between a transmission signal passing through a path R₁ and a transmission signal passing through a path R₂, as shown in FIG. 5

FIG. 5 is an illustrative diagram showing a coupling from the first input/output terminal 11 to the second input/output terminal 12.

The path R₁ is a path through which a transmission signal inputted from the first input/output terminal 11 passes through the first matching circuit 27, the second phase shifter 25, the directional coupler 23, the first radiating element 21, the second radiating element 22, the first phase shifter 24, the directional coupler 23, the third phase shifter 26, and the second matching circuit 28 and reaches the second input/output terminal 12.

The path R₂ is a path through which a transmission signal inputted from the first input/output terminal 11 passes through the first matching circuit 27, the second phase shifter 25, the directional coupler 23, the first phase shifter 24, the second radiating element 22, the first radiating element 21, the directional coupler 23, the third phase shifter 26, and the second matching circuit 28 and reaches the second input/output terminal 12.

In the branch (1), the amount of phase shift of the first phase shifter 24 is 0 degrees and the amount of phase shift of the second phase shifter 25 is θ/2 degrees.

Therefore, when the phase of the transmission signal inputted from the first input/output terminal 11 is 0 degrees, the phase of the transmission signal passing through the path R₁ is θ/2 degrees at the second terminal 23b of the directional coupler 23.

In addition, the phase of the transmission signal passing through the path R₂ is θ/2+ϕ+(π−ϕ)=(θ/2+π) degrees at the second terminal 23b.

At the second terminal 23b, the phase difference between the phase of the transmission signal passing through the path R₁ and the phase of the transmission signal passing through the path R₂ is π.

Thus, the transmission signal passing through the path R₁ and the transmission signal passing through the path R₂ have an equal amplitude and an opposite phase and cancel each other out at the second terminal 23b, and thus, the coupling from the first input/output terminal 11 to the second input/output terminal 12 is reduced.

For a coupling from the second input/output terminal 12 to the first input/output terminal 11 when the branch is the branch (2), though not shown, as with the branch (1), there are two paths of transmission signals. Here, the two paths are a path R₃ and a path R₄.

The path R₃ is a path through which a transmission signal inputted from the second input/output terminal 12 passes through the second matching circuit 28, the third phase shifter 26, the directional coupler 23, the first phase shifter 24, the second radiating element 22, the first radiating element 21, the directional coupler 23, the second phase shifter 25, and the first matching circuit 27 and reaches the first input/output terminal 11.

The path R₄ is a path through which a transmission signal inputted from the second input/output terminal 12 passes through the second matching circuit 28, the third phase shifter 26, the directional coupler 23, the first radiating element 21, the second radiating element 22, the first phase shifter 24, the directional coupler 23, the second phase shifter 25, and the first matching circuit 27 and reaches the first input/output terminal 11.

In the branch (2), the amount of phase shift of the first phase shifter 24 is 0 degrees and the amount of phase shift of the third phase shifter 26 is θ/2 degrees.

Therefore, when the phase of the transmission signal inputted from the second input/output terminal 12 is 0 degrees, the phase of the transmission signal passing through the path R₃ is θ/2 degrees at the first terminal 23a of the directional coupler 23.

In addition, the phase of the transmission signal passing through the path R₄ is θ/2+(π−ϕ)+=(θ/2+π) degrees at the first terminal 23a.

At the first terminal 23a, the phase difference between the phase of the transmission signal passing through the path R₃ and the phase of the transmission signal passing through the path R₄ is π.

Thus, the transmission signal passing through the path R₃ and the transmission signal passing through the path R₄ have an equal amplitude and an opposite phase and cancel each other out at the first terminal 23a, and thus, the coupling from the second input/output terminal 12 to the first input/output terminal 11 is reduced.

In the antenna device 4, since the first matching circuit 27 and the second matching circuit 28 are mounted, signal reflection at the first input/output terminal 11 and the second input/output terminal 12 can be suppressed.

Suppose an antenna device without the first matching circuit 27 and the second matching circuit 28 in the antenna device 4 shown in FIG. 2.

In such a supposed antenna device, it is supposed that signal reflection at the first radiating element 21 is 0 and signal reflection at the second radiating element 22 is 0.

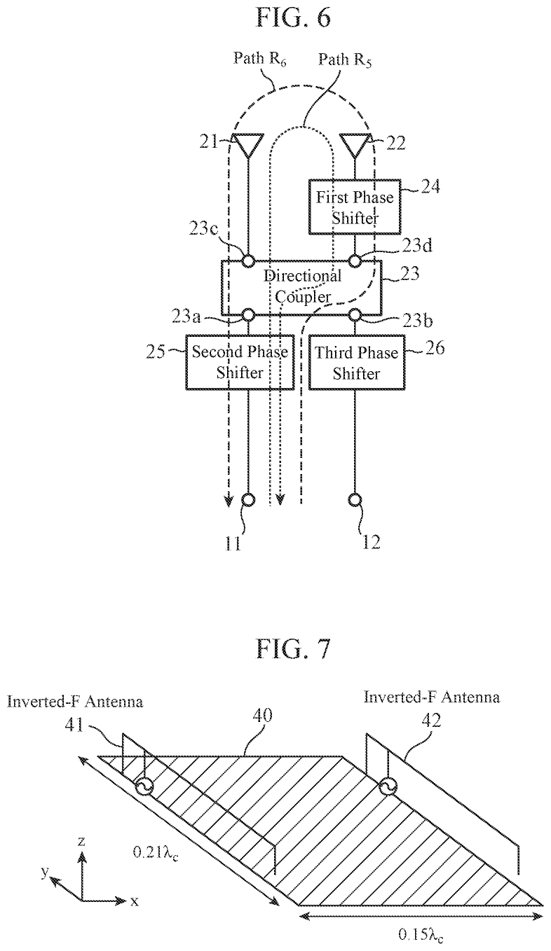

In the supposed antenna device, when the branch is the branch (1) or the branch (3), as shown in FIG. 6, a reflection of a transmission signal passing through a path R₅ and a reflection of a transmission signal passing through a path R₆ occur at the first input/output terminal 11.

FIG. 6 is an illustrative diagram showing reflections of transmission signals at the first input/output terminal 11.

The path R₅ is a path through which a transmission signal inputted from the first input/output terminal 11 passes through the second phase shifter 25, the directional coupler 23, the first radiating element 21, the second radiating element 22, the first phase shifter 24, the directional coupler 23, and the second phase shifter 25 and reaches the first input/output terminal 11.

The path R₆ is a path through which a transmission signal inputted from the first input/output terminal 11 passes through the second phase shifter 25, the directional coupler 23, the first phase shifter 24, the second radiating element 22, the first radiating element 21, the directional coupler 23, and the second phase shifter 25 and reaches the first input/output terminal 11.

The antenna device 4 shown in FIG. 2 has the first matching circuit 27 and the second matching circuit 28 mounted thereon.

The first matching circuit 27 matches the impedance seen from the first input/output terminal 11 toward the second phase shifter 25 to the impedance seen from the first input/output terminal 11 toward the transmission/reception switching switch 3.

Therefore, in the antenna device 4 shown in FIG. 2, when the branch is the branch (1) or the branch (3), reflection of the transmission signal passing through the path R₅ and reflection of the transmission signal passing through the path R₆ are suppressed by the operation of the first matching circuit 27.

The second matching circuit 28 matches the impedance seen from the second input/output terminal 12 toward the third phase shifter 26 to the impedance seen from the second input/output terminal 12 toward the transmission/reception switching switch 3.

Therefore, in the antenna device 4 shown in FIG. 2, when the branch is the branch (2) or the branch (4), signal reflection at the second input/output terminal 12 is suppressed by the operation of the second matching circuit 28.

Suppose an antenna device without the second phase shifter 25 and the third phase shifter 26 in the antenna device 4 shown in FIG. 2.

In such a supposed antenna device, a reflection phase obtained in the mode (1) is smaller by θ than a reflection phase obtained in the mode (2). In the assumed antenna device, even without the second phase shifter 25 and the third phase shifter 26, a reflection amplitude obtained in the mode (1) and a reflection amplitude in the mode (2) are identical.

The antenna device 4 shown in FIG. 2 includes the second phase shifter 25 and the third phase shifter 26 to make the reflection phase in the mode (1) and the reflection phase in the mode (2) the same.

The amount of phase shift of each of the second phase shifter 25 and the third phase shifter 26 varies between the mode (1) and the mode (2).

The amount of phase shift in the mode (1) is θ/2 and the amount of phase shift in the mode (2) is 0.

In the antenna device 4 shown in FIG. 2, since the reflection phase in the mode (1) and the reflection phase in the mode (2) are identical, each of the first matching circuit 27 and the second matching circuit 28 can be used in either of the mode (1) and the mode (2).

Here, the effectiveness of the antenna device 4 shown in FIG. 2 is considered using a two-element antenna array shown in FIG. 7 as an example.

In general, it is known that when the distance between two radiating elements is equal to or less than one-half of the wavelength of a transmission signal, mutual coupling between two input/output terminals increases and an antenna device does not effectively operate. Here, it will be explained that the antenna device 4 shown in FIG. 2 effectively operates even when the distance between the first radiating element 21 and the second radiating element 22 is equal to or less than one-half of the wavelength of a transmission signal.

The two-element antenna array shown in FIG. 7 has two inverted-F antennas 41 and 42 placed on a square ground plate 40.

In FIG. 7, λc is the free space wavelength of a transmission signal at the frequency (operating frequency) fc.

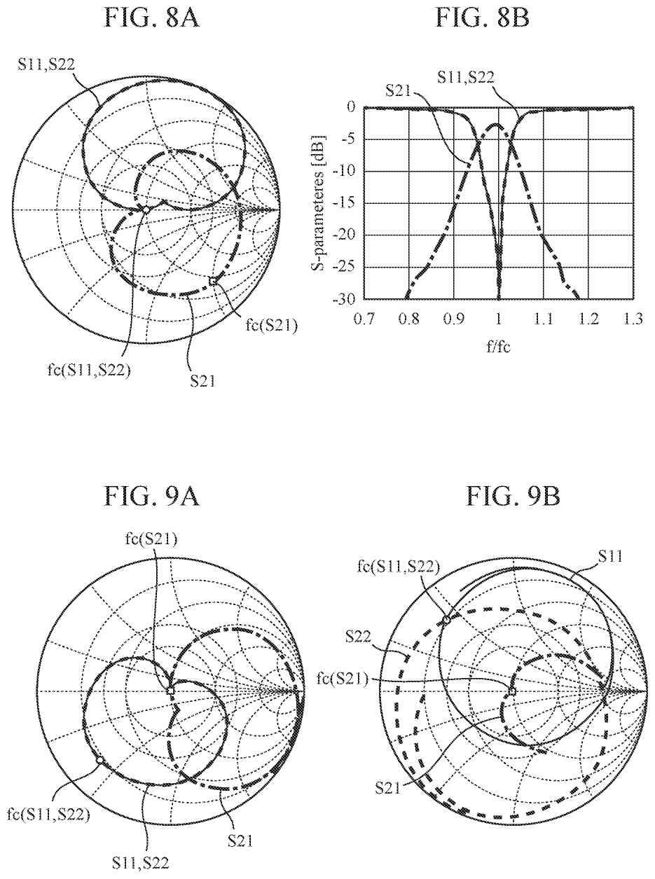

FIG. 8 is an illustrative diagram showing simulation results of S-parameters of the two-element antenna array shown in FIG. 7. S-parameter simulation is performed by, for example, a computer.

FIG. 8A is a Smith chart showing S-parameters and FIG. 8B is an illustrative diagram showing frequency characteristics of amplitude. In FIG. 8B, frequency is normalized by the operating frequency fc.

In an example of FIG. 7, the distance between the inverted-F antenna 41 and the inverted-F antenna 42 is 0.15 λc and is shorter than 0.5 λc.

It can be seen from FIG. 8B that coupling |S<| between the inverted-F antenna 41 and the inverted-F antenna 42 is about −3 dB at the operating frequency fc and is very high.

Next, a case in which the two-element antenna array shown in FIG. 7 is applied to an antenna device is considered.

First, an antenna device without the second phase shifter 25, the third phase shifter 26, the first matching circuit 27, and the second matching circuit 28 in the antenna device 4 shown in FIG. 2 is considered.

The antenna device considered uses the inverted-F antenna 41 as the first radiating element 21 and uses the inverted-F antenna 42 as the second radiating element 22.

FIG. 9 is an illustrative diagram showing results of S-parameter simulation obtained when an inverted-F antenna 41, 42 is viewed from each of the first input/output terminal 11 and the second input/output terminal 12. In the S-parameter simulation, θ=90° and ϕ=−90°.

FIG. 9A is a Smith chart showing S-parameters for a case of the mode (1) and FIG. 9B is a Smith chart showing S-parameters for a case of the mode (2).

As shown in FIGS. 9A and 9B, it can be seen that in either of the mode (1) and the mode (2) the coupling |S<| between the inverted-F antenna 41 and the inverted-F antenna 42 is located at the center of the Smith chart and that the coupling is sufficiently low.

At the operating frequency fc, the distance from the center of the Smith chart is the same for both S11 in the mode (1) and S11 in the mode (2), but their locations are different. Likewise, at the operating frequency fc, the distance of S22 from the center of the Smith chart in the mode (1) is the same as the distance of S22 from the center of the Smith chart in the mode (2), but their locations are different. This indicates that the amplitude is the same for both the mode (1) and the mode (2), but the phase is different between the mode (1) and the mode (2). That is, it indicates that a matching circuit required in the mode (1) differs from a matching circuit required in the mode (2), and there is a need to mount different matching circuits for the mode (1) and the mode (2).

Therefore, the antenna device considered requires a first matching circuit 27 for the mode (1) and a second matching circuit 28 for the mode (1), and a first matching circuit 27 for the mode (2) and a second matching circuit 28 for the mode (2).

Next, an antenna device which is a version of the antenna device 4 shown in FIG. 2 on which the second phase shifter 25 and the third phase shifter 26 are mounted, but the first matching circuit 27 and the second matching circuit 28 are not mounted is considered.

The antenna device considered uses the inverted-F antenna 41 as the first radiating element 21 and uses the inverted-F antenna 42 as the second radiating element 22.

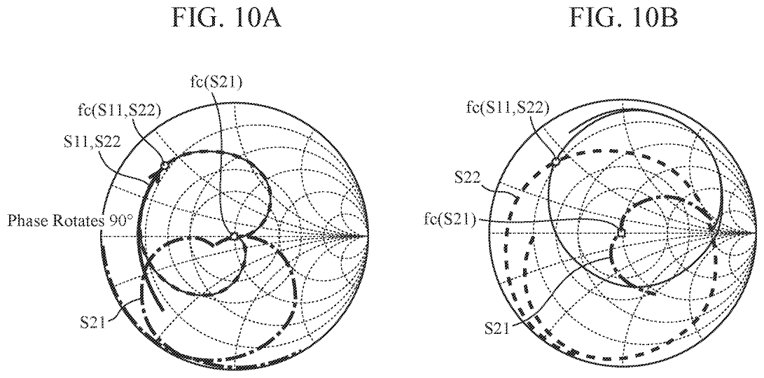

FIG. 10 is an illustrative diagram showing results of S-parameter simulation obtained when an inverted-F antenna 41, 42 is viewed from each of the first input/output terminal 11 and the second input/output terminal 12. In the S-parameter simulation, θ=90° and ϕ=−90°.

FIG. 10A is a Smith chart showing S-parameters for a case of the mode (1) and FIG. 10B is a Smith chart showing S-parameters for a case of the mode (2).

As shown in FIGS. 10A and 10B, it can be seen that in either of the mode (1) and the mode (2) the coupling |S21| between the inverted-F antenna 41 and the inverted-F antenna 42 is located at the center of the Smith chart and that the coupling is sufficiently low.

At the operating frequency fc, by mounting the second phase shifter 25 and the third phase shifter 26, the phase in the mode (1) rotates 90° and the location of S11 in the mode (1) coincides with the location of S11 in the mode (2). In addition, the location of S22 in the mode (1) coincides with the location of S22 in the mode (2). This indicates that a matching circuit required in the mode (1) and a matching circuit required in the mode (2) can be used in a sharing manner.

Next, the antenna device 4 shown in FIG. 2 having the second phase shifter 25, the third phase shifter 26, the first matching circuit 27, and the second matching circuit 28 mounted thereon is considered.

The antenna device 4 shown in FIG. 2 uses the inverted-F antenna 41 as the first radiating element 21 and uses the inverted-F antenna 42 as the second radiating element 22.

In the antenna device 4 shown in FIG. 2, the first matching circuit 27 using three lumped elements is shown. However, this is merely an example and a first matching circuit 27 using two lumped elements may be used.

For the two lumped elements, for example, a jumper element connected in series between the other end of the second phase shifter 25 and the first input/output terminal 11, and a parallel capacitor connected at its one end to one end or the other end of the jumper element and grounded at its other end may be used.

In addition, in the antenna device 4 shown in FIG. 2, the second matching circuit 28 using three lumped elements is shown. However, this is merely an example and a second matching circuit 28 using two lumped elements may be used.

For the two lumped elements, for example, a jumper element connected in series between the other end of the third phase shifter 26 and the second input/output terminal 12, and a parallel capacitor connected at its one end to one end or the other end of the jumper element and grounded at its other end may be used.

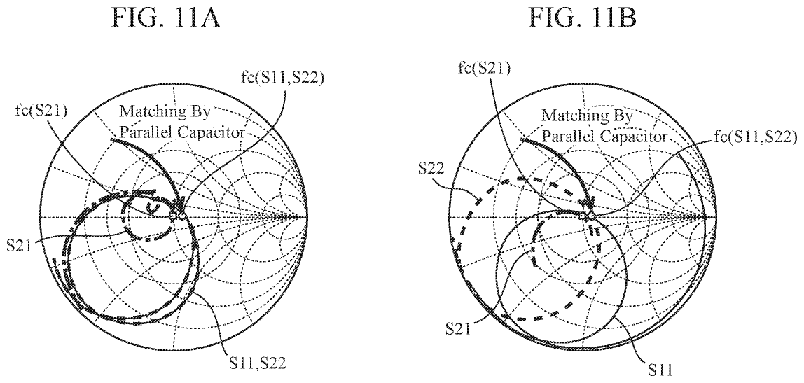

FIG. 11 is an illustrative diagram showing results of S-parameter simulation obtained when an inverted-F antenna 41, 42 is viewed from each of the first input/output terminal 11 and the second input/output terminal 12. In the S-parameter simulation, θ=90° and ϕ=−90°.

FIG. 11A is a Smith chart showing S-parameters for a case of the mode (1) and FIG. 11B is a Smith chart showing S-parameters for a case of the mode (2).

As shown in FIGS. 11A and 11B, it can be seen that in both the mode (1) and the mode (2) the coupling |S21| between the inverted-F antenna 41 and the inverted-F antenna 42 is located at the center of the Smith chart and that the coupling is sufficiently low.

At the operating frequency fc, the location of S11 in the mode (1) coincides with the location of S11 in the mode (2). In addition, it can be seen that the location of S11 in the mode (1) and the location of S11 in the mode (2) are located at substantially the center of the Smith chart and reflection is sufficiently low. At the operating frequency fc, the location of S22 in the mode (1) coincides with the location of S22 in the mode (2). In addition, it can be seen that the location of S22 in the mode (1) and the location of S22 in the mode (2) are located at substantially the center of the Smith chart and reflection is sufficiently low.

The first matching circuit 27 of the antenna device 4 shown in FIG. 2 is appropriate to both the mode (1) and the mode (2), and the second matching circuit 28 is appropriate to both the mode (1) and the mode (2).

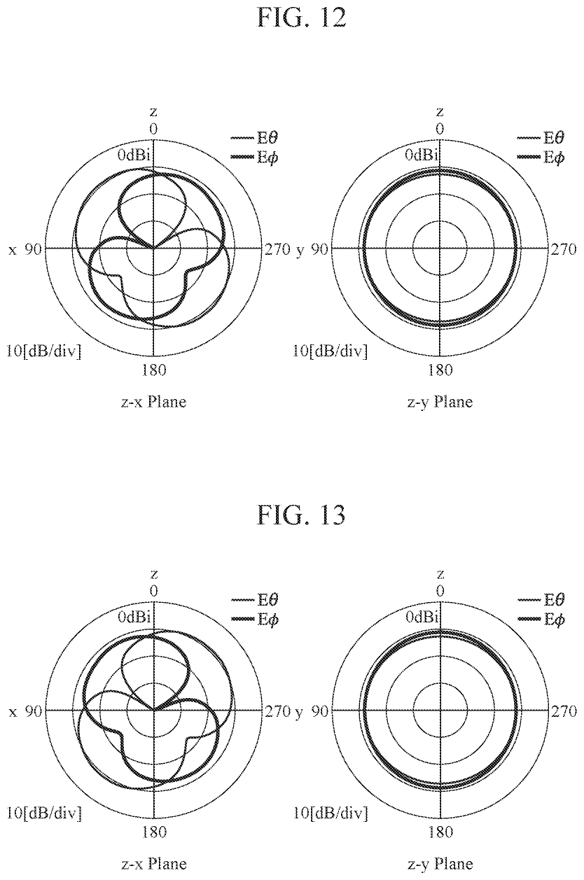

FIGS. 12 to 15 are illustrative diagrams showing simulation results of radiation patterns of the antenna device 4 shown in FIG. 2 in a z-x-plane shown in FIG. 7 in the modes (1) and (2), and simulation results of radiation patterns of the antenna device 4 shown in FIG. 2 in a z-y-plane shown in FIG. 7 in the modes (1) and (2).

FIG. 12 shows simulation results of radiation patterns obtained when the branch (1) in the mode (1) is used and the feed point is the first input/output terminal 11.

FIG. 13 shows simulation results of radiation patterns obtained when the branch (2) in the mode (1) is used and the feed point is the second input/output terminal 12.

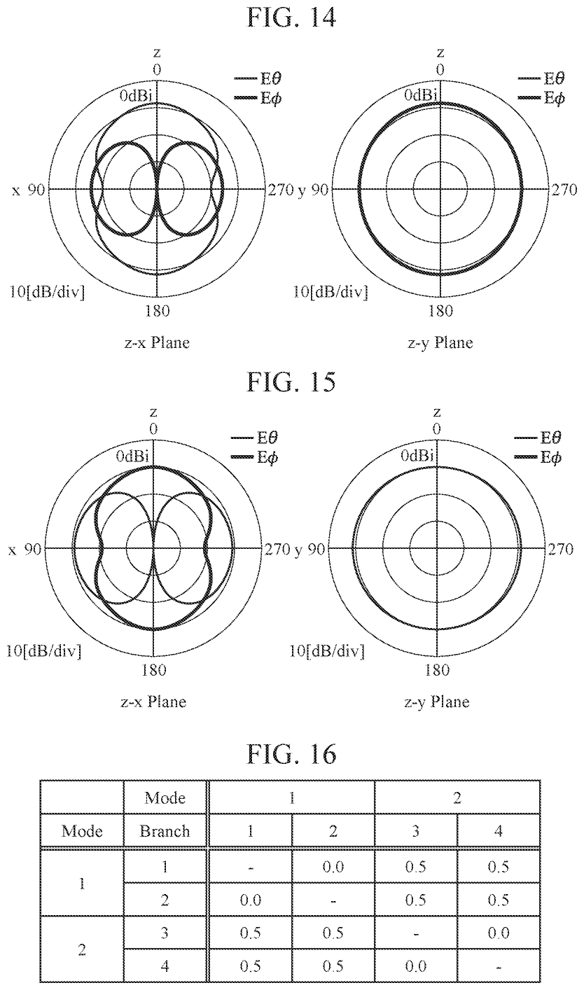

FIG. 14 shows simulation results of radiation patterns obtained when the branch (3) in the mode (2) is used and the feed point is the first input/output terminal 11.

FIG. 15 shows simulation results of radiation patterns obtained when the branch (4) in the mode (2) is used and the feed point is the second input/output terminal 12.

Comparing the simulation results shown in FIGS. 12 to 15, it can be seen that the radiation pattern varies between the branches (1) to (4).

FIG. 16 is an illustrative diagram showing simulation results for correlation coefficients between the branches (1) to (4).

The correlation between the first radiating element 21 and the second radiating element 22 is computed from a radiation pattern of the first radiating element 21 and a radiation pattern of the second radiating element 22.

FIG. 16 shows that the correlation coefficient between the branch (1) and the branch (2) is 0.0, the correlation coefficient between the branch (1) and the branch (3) is 0.5, and the correlation coefficient between the branch (1) and the branch (4) is 0.5.

In addition, FIG. 16 shows that the correlation coefficient between the branch (2) and the branch (3) is 0.5, and the correlation coefficient between the branch (2) and the branch (4) is 0.5.

Furthermore, FIG. 16 shows that the correlation coefficient between the branch (3) and the branch (4) is 0.0.

When the radiation pattern of the first radiating element 21 and the radiation pattern of the second radiating element 22 are similar to each other, the correlation increases, and when they are not similar to each other, the correlation decreases.

It is known that when the correlation coefficient between the first radiating element 21 and the second radiating element 22 is equal to or less than 0.5, the antenna device can obtain substantially equivalent diversity performance to that obtained when the correlation coefficient is 0.

It can be seen from FIG. 16 that in the antenna device 4 shown in FIG. 2, the correlation coefficients between the branches (1) to (4) are equal to or less than 0.5.

In the above-described Embodiment 1, the antenna device is constructed to include the first phase shifter 24 connected at its one end to the fourth terminal 23d of the directional coupler 23; the second phase shifter 25 connected at its one end to the first terminal 23a of the directional coupler 23; the third phase shifter 26 connected at its one end to the second terminal 23b of the directional coupler 23; the first matching circuit 27 connected at its one end to the other end of the second phase shifter 25 and connected at its other end to the first input/output terminal 11; and the second matching circuit 28 connected at its one end to the other end of the third phase shifter 26 and connected at its other end to the second input/output terminal 12. Therefore, the antenna device according to Embodiment 1 can suppress signal reflection in a case in which the distance between the first radiating element 21 and the second radiating element 22 is short.

In Embodiment 1, the effectiveness of the antenna device is considered assuming that each of the first radiating element 21 and the second radiating element 22 is an inverted-F antenna.

However, each of the first radiating element 21 and the second radiating element 22 is not limited to an inverted-F antenna and may be a radiating element with large reflection.

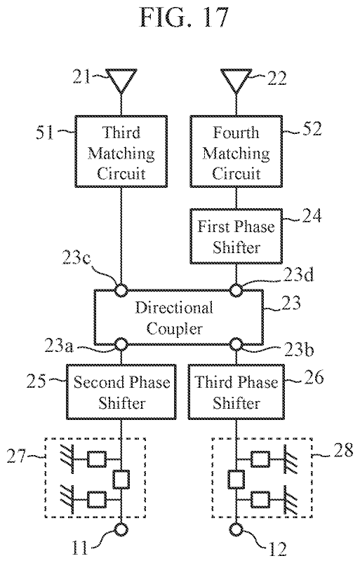

When, for example, a radiating element with large reflection is used as each of the first radiating element 21 and the second radiating element 22, the antenna device includes, as shown in FIG. 17, a third matching circuit 51 and a fourth matching circuit 52.

FIG. 17 is a configuration diagram showing another antenna device 4 according to Embodiment 1.

In FIG. 17, the same reference signs as those in FIG. 2 indicate the same or corresponding portions and thus description thereof is omitted.

The third matching circuit 51 is connected at its one end to the third terminal 23c and connected at its other end to the first radiating element 21.

The third matching circuit 51 is a circuit for matching the impedance seen from the third terminal 23c toward a first radiating element 21 to the impedance seen from the third terminal 23c toward a directional coupler 23.

The fourth matching circuit 52 is connected at its one end to the other end of the first phase shifter 24 and connected at its other end to the second radiating element 22.

The fourth matching circuit 52 is a circuit for matching the impedance seen from the other end of the first phase shifter 24 toward a second radiating element 22 to the impedance seen from the other end of the first phase shifter 24 toward a first phase shifter 24.

As with the first matching circuit 27 shown in FIG. 2, each of the third matching circuit 51 and the fourth matching circuit 52 may be a Π-circuit including three or less lumped elements, or may be a T-circuit including three or less lumped elements.

The antenna device 4 shown in FIG. 2 is described as one used as a diversity antenna. The antenna device 4 shown in FIG. 2 has low correlation between the first radiating element 21 and the second radiating element 22, and thus, can also be used as a Multiple Input Multiple Output (MIMO) antenna.

### Embodiment 2

In the antenna device 4 according to Embodiment 1, an example in which the directional coupler 23 is a branch-line directional coupler is shown.

In Embodiment 2, an antenna device 4 is explained that includes a directional coupler 60 being a 90°-hybrid circuit including a plurality of lumped elements.

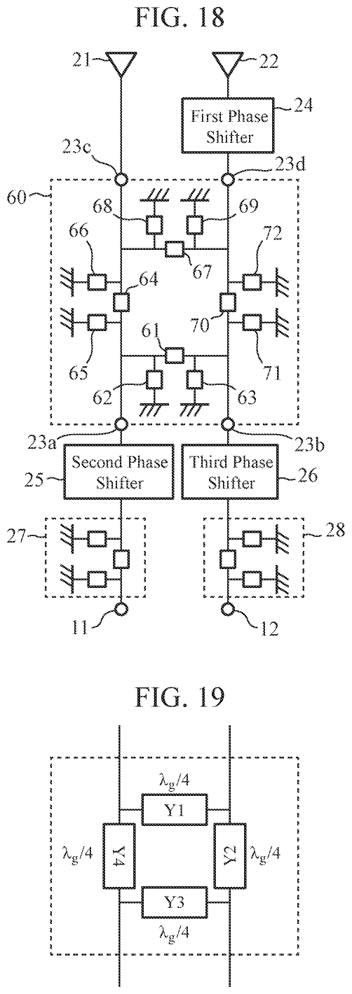

FIG. 18 is a configuration diagram showing the antenna device 4 according to Embodiment 2.

In FIG. 18, the same reference signs as those in FIG. 2 indicate the same or corresponding portions and thus description thereof is omitted.

The directional coupler 60 is a circuit having the same function as the directional coupler 23 shown in FIG. 2.

The directional coupler 60 is a 90°-hybrid circuit including first to twelfth lumped elements.

A first lumped element 61 is connected at its one end to the first terminal 23a and connected at its other end to the second terminal 23b.

A second lumped element 62 is connected at its one end to the one end of the first lumped element 61 and grounded at its other end.

A third lumped element 63 is connected at its one end to the other end of the first lumped element 61 and grounded at its other end.

The first lumped element 61, the second lumped element 62, and the third lumped element 63 form a first Π-circuit.

A fourth lumped element 64 is connected at its one end to the first terminal 23a and connected at its other end to the third terminal 23c.

A fifth lumped element 65 is connected at its one end to the one end of the fourth lumped element 64 and grounded at its other end.

A sixth lumped element 66 is connected at its one end to the other end of the fourth lumped element 64 and grounded at its other end.

The fourth lumped element 64, the fifth lumped element 65, and the sixth lumped element 66 form a second Π-circuit.

A seventh lumped element 67 is connected at its one end to the third terminal 23c and connected at its other end to the fourth terminal 23d.

An eighth lumped element 68 is connected at its one end to the one end of the seventh lumped element 67 and grounded at its other end.

A ninth lumped element 69 is connected at its one end to the other end of the seventh lumped element 67 and grounded at its other end.

The seventh lumped element 67, the eighth lumped element 68, and the ninth lumped element 69 form a third Π-circuit.

A tenth lumped element 70 is connected at its one end to the second terminal 23b and connected at its other end to the fourth terminal 23d.

An eleventh lumped element 71 is connected at its one end to the one end of the tenth lumped element 70 and grounded at its other end.

A twelfth lumped element 72 is connected at its one end to the other end of the tenth lumped element 70 and grounded at its other end.

The tenth lumped element 70, the eleventh lumped element 71, and the twelfth lumped element 72 form a fourth Π-circuit.

Components other than the directional coupler 60 are the same as those according to Embodiment 1, and thus, only the directional coupler 60 will be described here.

For example, suppose that a directional coupler is constructed as a branch-line 90°-hybrid circuit as shown in FIG. 19.

FIG. 19 is a configuration diagram showing the branch-line 90°-hybrid circuit.

The branch-line 90°-hybrid circuit is constructed of a ring-shaped transmission line arranged in a substantially square.

Each of four transmission lines included in the ring-shaped transmission line is about λg/4 in length. The parameter λg is the guide wavelength at the operating frequency fc.

Therefore, when the branch-line 90°-hybrid circuit is formed on a substrate, the length of one side of the 90°-hybrid circuit is shorter than the free space wavelength λc due to a wavelength reduction caused by a dielectric included in the substrate.

By replacing each of the four transmission lines with a Π-circuit including three lumped elements as shown in FIG. 18, further circuit miniaturization can be achieved.

Each of characteristic admittance Y₁ of the first Π-circuit, characteristic admittance Y₂ of the second Π-circuit, characteristic admittance Y₃ of the third H-circuit, and characteristic admittance Y₄ of the fourth Π-circuit is represented by the following equations (1) to (4):

$$\begin{matrix}{Y}_{1} = \frac{1}{\sqrt{1 - {k}^{2}}} \sqrt{{G}_{1} {G}_{2}} & ( 1 ) \\ {Y}_{2} = \frac{k}{\sqrt{1 - {k}^{2}}} \sqrt{{G}_{2} {G}_{3}} & ( 2 ) \\ {Y}_{3} = \frac{1}{\sqrt{1 - {k}^{2}}} \sqrt{{G}_{3} {G}_{4}} & ( 3 ) \\ {Y}_{4} = \frac{k}{\sqrt{1 - {k}^{2}}} \sqrt{{G}_{4} {G}_{1}} & ( 4 )\end{matrix}$$

In equations (1) to (4), G₁ is the load conductance of the first terminal 23a, G₂ is the load conductance of the second terminal 23b, G₃ is the load conductance of the third terminal 23c, and G₄ is the load conductance of the fourth terminal 23d.

The parameter k is the degree of coupling of the directional coupler 60.

Each of capacitance C₁ of the first Π-circuit, capacitance C₂ of the second Π-circuit, capacitance C₃ of the third Π-circuit, and capacitance C₄ of the fourth Π-circuit is represented by the following equation (5):

$${C}_{i} = \frac{1}{{ω}_{c}} {Y}_{i} ( i = 1 , 2 , 3 , 4 ) \qquad ( 5 )$$

In equation (5), ω_{c} is angular frequency at the operating frequency fc.

Each of inductance L₁ of the first Π-circuit, inductance L₂ of the second Π-circuit, inductance L₃ of the third Π-circuit, and inductance L₄ of the fourth Π-circuit is represented by the following equation (6):

$${L}_{i} = \frac{1}{{ω}_{c}} \frac{1}{{Y}_{i}} ( i = 1 , 2 , 3 , 4 ) \qquad ( 6 )$$

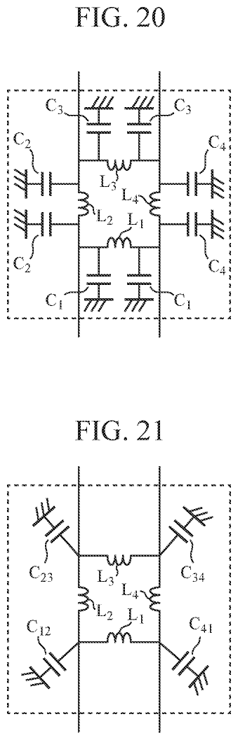

Therefore, the directional coupler 60 shown in FIG. 18 can be constructed by arranging capacitors and inductors of each of the first Π-circuit, the second Π-circuit, the third Π-circuit, and the fourth Π-circuit as shown in FIG. 20.

FIG. 20 is a configuration diagram showing the directional coupler 60 including capacitors and inductors.

Note, however, that each Π-circuit is not limited to one having two capacitors and an inductor arranged therein as shown in FIG. 20.

For example, although the directional coupler 60 shown in FIG. 20 includes eight capacitors in total, the directional coupler 60 may include four capacitors in total by coupling two adjacent capacitors together.

FIG. 21 is a configuration diagram showing a directional coupler 60 including four capacitors in total.

The directional coupler 60 shown in FIG. 21 includes a capacitor with capacitance C₁₂, a capacitor with capacitance C₂₃, a capacitor with capacitance C₃₄, and a capacitor with capacitance C₄₁.

The capacitor with capacitance C₁₂ is a capacitor obtained by coupling together a capacitor with capacitance C₁ shown in FIG. 20 (a capacitor on the left side in the drawing) and a capacitor with capacitance C₂ shown in FIG. 20 (a capacitor on the bottom side in the drawing).

The capacitor with capacitance C₂₃ is a capacitor obtained by coupling together a capacitor with capacitance C₂ shown in FIG. 20 (a capacitor on the top side in the drawing) and a capacitor with capacitance C₃ shown in FIG. 20 (a capacitor on the left side in the drawing).

The capacitor with capacitance C₃₄ is a capacitor obtained by coupling together a capacitor with capacitance C₃ shown in FIG. 20 (a capacitor on the right side in the drawing) and a capacitor with capacitance C₄ shown in FIG. 20 (a capacitor on the top side in the drawing).

The capacitor with capacitance C₄₁ is a capacitor obtained by coupling together a capacitor with capacitance C₄ shown in FIG. 20 (a capacitor on the bottom side in the drawing) and a capacitor with capacitance C₁ shown in FIG. 20 (a capacitor on the right side in the drawing).

Although here an example in which the directional coupler 60 includes four Π-circuits is shown, instead of each Π-circuit, a T-circuit including two series inductors and one parallel capacitor may be used.

Note that a free combination of the embodiments, modifications to any component in the embodiments, or omissions of any component in the embodiments are possible.

### INDUSTRIAL APPLICABILITY

One or more embodiments in this disclosure are suitable for an antenna device including a first radiating element and a second radiating element.

Furthermore, one or more embodiments in this disclosure are suitable for a wireless communication device including the antenna device.

### REFERENCE SIGNS LIST

1: transmitter, 2: receiver, 3: transmission/reception switching switch, 4: antenna device, 11: first input/output terminal, 12: second input/output terminal, 21: first radiating element, 22: second radiating element, 23: directional coupler, 23a: first terminal, 23b: second terminal, 23c: third terminal, 23d: fourth terminal, 24: first phase shifter, 25: second phase shifter, 26: third phase shifter, 27: first matching circuit, 28: second matching circuit, 31, 32: switch, 33: line, 34: bypass line, 40: ground plate, 41, 42: inverted-F antenna, 51: third matching circuit, 52: fourth matching circuit, 60: directional coupler, 61: first lumped element, 62: second lumped element, 63: third lumped element, 64: fourth lumped element, 65: fifth lumped element, 66: sixth lumped element, 67: seventh lumped element, 68: eighth lumped element, 69: ninth lumped element, 70: tenth lumped element, 71: eleventh lumped element, and 72: twelfth lumped element.

1. An antenna device comprising:
a directional coupler for splitting, when a signal is inputted to the directional coupler from a first terminal or a second terminal, the signal into signals, outputting one split signal to a third terminal, and outputting an other split signal to a fourth terminal;
a first radiating element connected to the third terminal;
a first phase shifter having one end connected to the fourth terminal;
a second radiating element connected to an other end of the first phase shifter;
a second phase shifter having one end connected to the first terminal;
a third phase shifter having one end connected to the second terminal;
a first matching circuit having one end connected to an other end of the second phase shifter and having an other end connected to a first input/output terminal; and
a second matching circuit having one end connected to an other end of the third phase shifter and having an other end connected to a second input/output terminal.

2. The antenna device according to claim 1, wherein
when the signal is inputted to the directional coupler from the first terminal, the directional coupler sets a phase difference of the other split signal with respect to the one split signal to ϕ degrees, or when the signal is inputted to the directional coupler from the second terminal, the directional coupler sets a phase difference of the one split signal with respect to the other split signal to (π−ϕ) degrees, and
when an amount of phase shift of the first phase shifter is 0 degrees, an amount of phase shift of each of the second phase shifter and the third phase shifter is one-half of 0 degrees, and when the amount of phase shift of the first phase shifter is 0 degrees, the amount of phase shift of each of the second phase shifter and the third phase shifter is 0 degrees.

3. The antenna device according to claim 2, wherein
the first phase shifter includes:
a line having a line length corresponding to an amount of phase shift of 0 degrees; and
a switch for connecting the fourth terminal to the second radiating element when the amount of phase shift is 0 degrees, or connecting the fourth terminal to one end of the line and connecting an other end of the line to the second radiating element when the amount of phase shift is θ degrees.

4. The antenna device according to claim 2, wherein
the second phase shifter includes:
a line having a line length corresponding to an amount of phase shift of one-half of θ degrees; and
a switch for connecting the first terminal to the one end of the first matching circuit when the amount of phase shift is 0 degrees, or connecting the first terminal to one end of the line and connecting an other end of the line to the one end of the first matching circuit when the amount of phase shift is one-half of θ degrees.

5. The antenna device according to claim 2, wherein
the third phase shifter includes:
a line having a line length corresponding to an amount of phase shift of one-half of θ degrees; and
a switch for connecting the second terminal to the one end of the second matching circuit when the amount of phase shift is 0 degrees, or connecting the second terminal to one end of the line and connecting an other end of the line to the one end of the second matching circuit when the amount of phase shift is one-half of θ degrees.

6. The antenna device according to claim 1, wherein the directional coupler is a branch-line directional coupler.

7. The antenna device according to claim 1, wherein the directional coupler is a 90°-hybrid circuit including a plurality of lumped elements.

8. The antenna device according to claim 1, wherein a distance between the first radiating element and the second radiating element is greater than 0 and equal to or less than one-half of a wavelength of the signal inputted from the first terminal or the second terminal.

9. The antenna device according to claim 1, comprising:
a third matching circuit having one end connected to the third terminal and having an other end connected to the first radiating element; and
a fourth matching circuit having one end connected to the other end of the first phase shifter and having an other end connected to the second radiating element.

10. A wireless communication device comprising an antenna device, wherein the antenna device includes:
a directional coupler for splitting, when a signal is inputted to the directional coupler from a first terminal or a second terminal, the signal into signals, outputting one split signal to a third terminal, and outputting an other split signal to a fourth terminal;
a first radiating element connected to the third terminal;
a first phase shifter having one end connected to the fourth terminal;
a second radiating element connected to an other end of the first phase shifter;
a second phase shifter having one end connected to the first terminal;
a third phase shifter having one end connected to the second terminal;
a first matching circuit having one end connected to an other end of the second phase shifter and having an other end connected to a first input/output terminal; and
a second matching circuit having one end connected to an other end of the third phase shifter and having an other end connected to a second input/output terminal.
